(19) United States
(12) Patent Application Publication
(10) Pub. No.: US 2020/0122640 A1
(43) Pub. Date: Apr. 23, 2020

(54) Configurable vehicle camera and video connecting cable system with interchangeable modules

(71) Applicant: Philip Maeda, Torrance, CA (US)

(72) Inventor: Philip Maeda, Torrance, CA (US)

(73) Assignee: Rydeen North America, Inc., Torrance, CA (US)

(21) Appl. No.: 16/350,228

(22) Filed: Oct. 18, 2018

(51) Int. Cl. B60R 1/12; B60R 1/06; B60K 35/00

(52) U.S. Cl. CPC B60R 1/12; B60R 1/06; B60K 35/00; B60K 2350/106; B60R 2001/1253; B60R 2300/408; B60K 2350/307

(57) ABSTRACT

A cable connection system for use in a vehicle wherein the cable connects a rearview camera to the interior cabin of the vehicle. The cable connection system is designed such that the power converter module, a part of the cable system, can be easily replaced if damaged without the remainder of the cable harness rerouted or reinstalled.

### BACKGROUND OF THE INVENTION

### 1. Field of the Invention

The present invention provides a multi-configurable cable system for connecting rear view and other onboard cameras to the vehicles 12-volt DC electrical system. The cable system is configured so that the power converter can be placed at either the front end of the cable system at the dash board of the vehicle or at the rear area of the vehicle where the camera is located. This configuration allows the installation to be simplified and offer more flexibility in the way the cabling system is used and installed and would allow alternative systems to be quickly added. The cable system consists of interconnected units that can be configured to work in many ways to allow flexibility in the placement of both needed connections and camera locations throughout the vehicle, enabling multiple devices and systems requiring similar arrangements to be connected. With this configuration, sections of the cable system as well as the voltage converter used to power the camera(s) can be replaced if needed without the removal of the entire cable system. The cable system contains ultra-small multi wire connectors that allows easy installation through tight areas and holes that may be needed for the cable to pass through.

### 2. Description of the Prior Art

Both cable assemblies and camera assemblies for use with vehicles have been disclosed in prior art. For example, U.S. Pat. No. 9,434,316 to Maeda discloses a cable assembly with very small multipin connectors that allows an easier system of installation for rear and other camera systems. The voltage reducer is installed at the rear of the vehicle in close proximity to the camera. This arraignment works well but lacks the flexibility needed for more complex installations.

U.S. Pat. No. 8,432,466 to Son discloses a monitoring camera assembly which includes a camera portion and a rear housing. The camera portion for sensing an image or object behind a vehicles includes a camera body and lens. The rear housing is installed on the license plate and supports the camera body; a first mechanical fastening device for fastening the front housing to the license plate being provided. The camera body and lens is secured to the front housing in a manner such that if the camera fails and needs to be replaced, a time consuming and costly effort would be required. Further the connector size and diameter makes it difficult for a connection to be made from the rear of the vehicle to the display device in the front passenger area of the vehicle.

What is desired is to provide a connecting cable that is ultra-small in diameter, can be configured in several ways for ease of installation and wherein individual components of the cabling system could be replaced if needed without the removal of the entire cable.

### SUMMARY OF THE INVENTION

The present invention provides a versatile connector for connecting both the power source for a video trigger and power for a vehicle camera system and which is configured for installation at the rear of the vehicle in close proximity to the camera or, at the front of the vehicle in the passenger compartment. The cabling system is configured based on the needs of the installer and provides an easy way to replace sections of failing or damaged wires without the need to replace and re-route the entire assembly including but not limited to the power reduction circuit. The flexibility of this system allows the power converter to be replaced with a similar unit enabling the connector to be used as proposed while also adding flexibility in the installation of other related systems minimizing the time and effort needed for installation of these systems. The system contains ultra-small connectors for ease of access through small holes needed for the installation and power demand of the camera and other systems. This system also allows an installer to mount the power reduction circuit either at the rear of the vehicle close to the camera or in the interior cabin or dash board where the connections needed can be more easily identified. It also allows the versatility in the configuration of the system so that in the case of a backup camera installation, the camera would not be dependent on the reverse light wiring and could run while driving if desired, power being provided from an additional source of power with the ignition ON. When the power converter is located in the forward portion of the system it can also be configured for several other optional and additional system installations. Damaged sections could also be replaced including the power reduction circuitry without the need of replacing the entire harness that would normally be very difficult and time consuming to complete. While utilizing the same cable system the converter can be replaced with other optional power converters that would allow for the quick and easy installation of other related systems such as side view cameras, blind spot detection and multiple cameras around and inside the vehicle. The cabling system could also be used for wiring and power distribution of top view or 360 degree camera systems that would aid in the operation of the vehicle.

The system design of the present invention enables the connectors and connector positions to be revisable and interchangeable so that the power connector can be placed in multiple positions within the harness. The complete connector itself is of a long length to connect the camera at the far rear of the vehicle, then routed throughout the vehicle and connected to a monitor or like device in the forward cabin to be viewable by the driver. This requires the often-complex routing of the cable throughout the cargo and passenger areas of the vehicle.

Without the interconnectivity features of the cable of the present invention a failure of any given portion would require replacement of the entire cable. This is especially critical in the voltage reduction circuit that could fail if any part of the assembly is damaged. For example, this could occur in a small collision where the rear cameras has been damaged and the wires shorted. In the event of any failure of the power converter unit, the unit could be removed white the remainder of the harness would not have to be rerouted or reinstalled. This saves countless hours in the servicing or replacement of the power converter or any section of the entire harness.

The present invention overcomes these obstacles by providing a connecting cable that is ultra-small in diameter, can be configured in several ways for ease of installation and individual components of the cabling system could be replaced if needed without the removal of the entire cable. The current invention also allows the connection of other systems while using the same cable configuration

### DESCRIPTION OF THE DRAWINGS

For a better understanding of the present invention as well as other objects and further features thereof, reference is made to the following description which is to be read in conjunction with the accompanying drawing therein:

FIG. 1 is a simplified representation of a vehicle having a voltage reducer module in the front of the vehicle;

FIG. 2 is similar to FIG. 1 with the voltage reducer in the rear position of the vehicle;

FIG. 3 is circuit schematic of a conventional voltage reducer module;

FIG. 4 is a simplified schematic of the cable assembly of the present invention;

FIG. 5 is similar to FIG. 4 with the voltage reducer in the forward position of the vehicle;

FIG. 6A shows the cable assembly of the present invention with an interchangeable power reducer module in the forward position;

FIG. 6B shows the cable assembly of the present invention with an alternative connector configuration;

FIGS. 7A and 7B show output connection from the power reducer; and

FIG. 8A-8C show various connector configurations.

### DESCRIPTION OF THE INVENTION

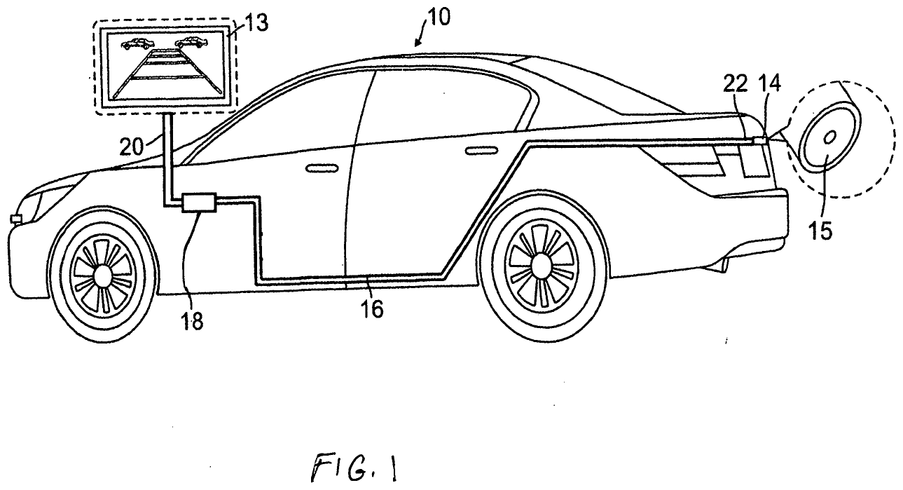

Referring now to FIG. 1, a simplified representation of a modern vehicle 10 is illustrated. In this figure, a dashboard mounted monitor 13 is shown for illustrative purposes, outside the vehicle 10. The image shown on the screen on monitor 13 is provided by backup camera 14, the camera having a lens 15 (note that the vehicle rearview mirror can combine the conventional mirror function with display monitor 13 for use with backup rear view camera 14). In accordance with the teachings of the present invention, a smart cable 16, with combined power and video lines, connects vehicle reducer module 18 to monitor portion 13 via leads 20 and 22. A portion of the cable 16 is utilized to couple reducer 18 to both backup camera 14 and to couple the video images detected thereby to monitor 13, whether positioned on the dashboard or formed as part of the rearview mirror assembly.

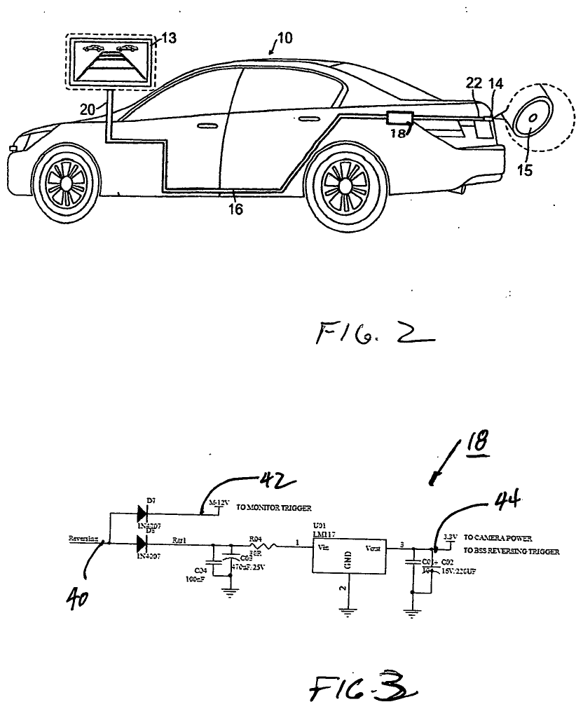

FIG. 2 is similar to FIG. 1 showing the voltage reducer module 18 in the rear position of vehicle 10.

FIG. 3 is a simplified circuit schematic of power reduction circuit, a common arrangement for rear camera wiring. The circuitry is preferably prefabricated within the power reducer module 18. When the vehicle is in reverse, a signal is generated on lead 40 which, in form, causes a monitor trigger signal to appear on lead 42 and to apply a camera power signal on lead 44.

FIG. 4 is a simplified schematic showing the cable assembly of the present invention with the power (voltage) reducer module 18 at the conventional rear position.

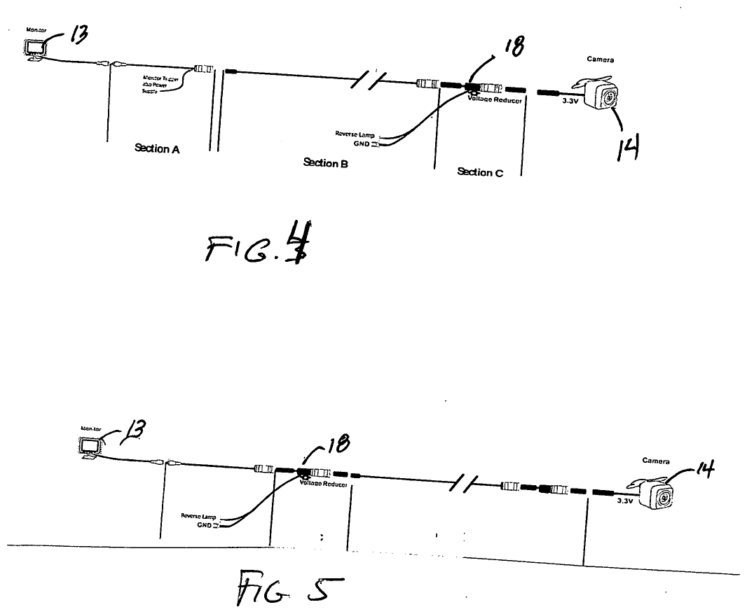

FIG. 5 is a simplified schematic showing the cable assembly of the present invention with the power reducer module 18 in the forward position.

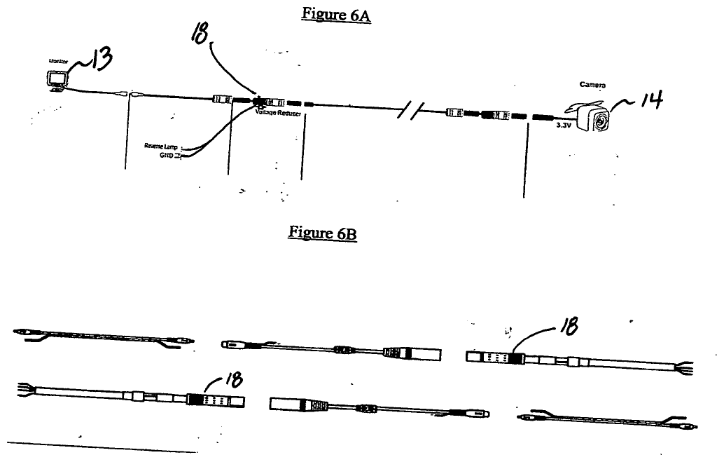

FIG. 6A is a simplified schematic showing the cable assembly of the present invention with an interchangeable power reducer module 18 in the forward position. Module 18 can be easily removed and replaced with a different power reducer module when necessary without compromising the other cable sections and functions. FIG. 6B shows the cable system in an alternative configuration.

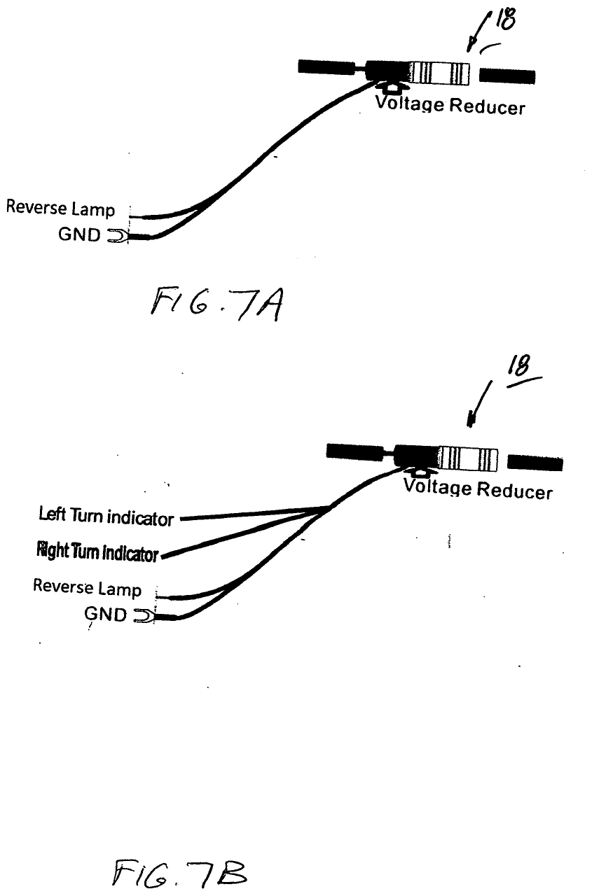

FIGS. 7A and 7B illustrates alternative uses for power reduction module 18 in addition to providing reverse camera power and a monitor trigger. Specifically, FIG. 7A shows output leads from voltage reducer module 18 being connected to the reverse lamp and ground whereas FIG. 7B shows output leads from voltage reducer 18 being connected to the left turn indicator, the right turn indicator, reverse lane and ground.

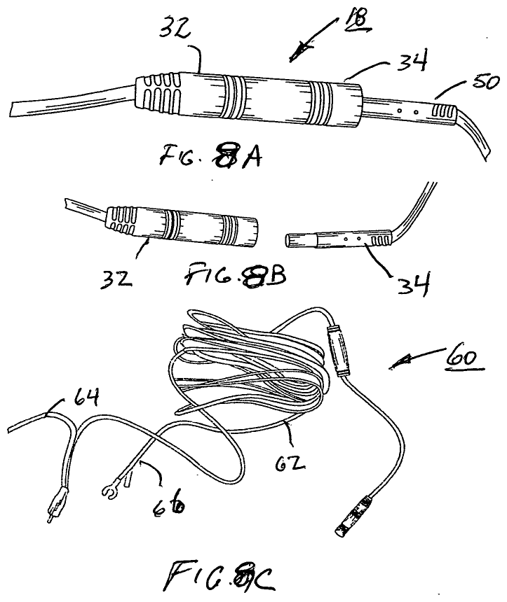

FIG. 8A-8C illustrate various connector configurations. FIG. 8A is a view of the connector 18 (a mini DIN connector) with output portion 32 and input portion 34 connected together and FIG. 8B is a view of the camera input plug 34 (a mini DIN connector) spaced apart from output portion 32. Output portion 34 is connected to cable 50 (the standard DIN connector is an electrical cable that plugs into an interface to connect devices. It comprises multiple pins with a circular protective sheath; the Mini-DIN was developed to avoid possible misconnections to a mating component). FIG. 8C is perspective view of the connector assembly of the present invention. Assembly 60 comprises an elongated wire harness 62 having lead 64 which connects camera 14 to monitor 13, lead 66 connecting power wire 68 to monitor 13. Clip 70 is coupled to the reducer 18, reducer 18 powering monitor 13 and back-up camera 14 (via leads 16 and 22 as shown in FIG. 1.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

1. A modular cable connection system that connects a vehicle exterior camera to an interior display in the passenger compartment of a vehicle comprising:
a modular cable connection for joining multiple portions of a cable assembly that can be interconnected with at least two lead pairs;
a power reduction circuit for the operation of an exterior camera that can be installed at either end of the cable; and
said connection system including means for transmitting power and video signals to said display.

2. The modular cable connection system of claim 1 for connecting an exterior camera to an interior display in the passenger compartment of said vehicle that contains interlinked modules that can be configured as needed for installation.

3. The modular cable connection system of claim 2 wherein multiple portions of a cable are interconnected with at least two lead pairs.

4. The modular cable connection system of claim 3 wherein sections of the cable can be removed or replaced individually without the need for the removal of the entire cable assembly.

5. A modular cable connection system that connects an exterior camera to an interior monitor or display in the passenger compartment of a vehicle comprising:
A modular cable connection system for joining multiple portions of a cable that can be interconnected with at least two lead pairs;
A modular cable connection system containing a power reduction circuit for the operation of an exterior camera the power reduction circuit capable of being installed at either end of the cable.

6. The modular cable connection system as in claim 5 whereby the power reduction circuit can be changed to allow installation of other systems and cameras while utilizing the same cable structure.

7. A modular connection system as in claim 6 wherein the said connector includes means for transmitting power and video signal to said display or monitor.

8. A modular cable connection system that connects an exterior camera to an interior monitor or display in the passenger compartment of a vehicle that contains interlinked modules that can be configured as needed for installation comprising;
means for joining multiple portions of a cable that can be interconnected with at least two lead pairs;
A power reduction circuit for the operation of an exterior camera the power reduction circuit capable of being installed at either end of the cable.

9. The modular cable connection system as of claim 8 wherein said connector includes means for transmitting power and video signals to said display or monitor.

10-15. (canceled)
